(19) United States
(12) Patent Application Publication
(10) Pub. No.: US 2008/0048965 A1
(43) Pub. Date: Feb. 28, 2008

(54) Driving system of liquid crystal display

(75) Inventor: Zhong-Ru Li, Shenzhen (CN)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/881,861

(22) Filed: Jul. 30, 2007

(30) Foreign Application Priority Data
Jul. 28, 2006 (TW) 95127762

(51) Int. Cl. G09G 3/36

(52) U.S. Cl. 345/99

(57) ABSTRACT

An exemplary driving system (100) of an LCD includes a control circuit (10) and a driving circuit (11). The control circuit includes a decoder circuit (13), a DC-DC converter (130), and a timing control circuit (14). The driving circuit includes a gate driver circuit (15), a source driver circuit (16), a pulse width modulation circuit (150), and a gamma circuit (160). The DC-DC converter is packaged in the decoder circuit. The pulse width modulation circuit is packaged in the gate driver circuit. The gamma circuit is packaged in the source driver circuit.

### FIELD OF THE INVENTION

The present invention relates to electrical driving systems employed in electronic apparatuses, and particularly to an packaged driving system of a liquid crystal display (LCD).

### GENERAL BACKGROUND

An LCD panel is a main part of an LCD. A typical LCD panel includes a plurality of scan lines, a plurality of data lines, and a plurality of thin film transistors (TFTs) each connected to a corresponding one of the scan lines and a corresponding one of the data lines. The LCD panel also includes a gate driver circuit for driving the plurality of scan lines, and a source driver circuit for driving the plurality of data lines.

The source driver circuit produces a plurality of gray scale voltages in order to drive the plurality of data lines. The gate driver receives a plurality of high-level gate voltages (VGHs) or low-level gate voltages (VGLs). The plurality of VGHs or VGLs turn on or turn off the corresponding TFTs via the corresponding scan lines. Normally, a value of the VGH is +15.x V (volts) or +24.x V, wherein x is any natural number; and a value of the VGL is −10.x V or −6.x V, wherein x is any natural number. For example, the VGH may be 15.3 V (when x=3), and the VGL may be 10.2 V (when x=2).

A timing control circuit is disposed in an exterior control circuit board that is positioned around the LCD panel. The timing control circuit generates timing control signals to control the timing sequence of the gate driver circuit and the source driver circuit. Each of the timing control circuit, the gate driver circuit, and the source driver circuit is driven by an operating voltage. The operating voltage is in a range of +2.7 V to +3.6 V; for example, +3 V.

The operating voltage, the VGHs, and the VGLs are all provided by a power supply circuit in the exterior control circuit board. The VGHs and the VGLs are then transmitted to the LCD panel via a flexible printed circuit (FPC), and finally transmitted to the gate driver circuit and the data driver via conductive lines in the LCD panel. Consequently, the circuit configuration of the LCD is complicated. Furthermore, the FPC includes a +3V operation voltage pin, a VGH pin, a VGL pin, a main operation voltage (AVDD) pin, and a gamma voltage pin. This means the cost of the FPC is quite high.

It is desired to provide a driving system of an LCD which overcomes the above-described deficiencies.

### SUMMARY

A driving system of an LCD includes a control circuit and a driving circuit. The control circuit includes a decoder circuit, a DC-DC converter, and a timing control circuit. The driving circuit includes a gate driver circuit, a source driver circuit, a pulse width modulation circuit, and a gamma circuit. The DC-DC converter is packaged in the decoder circuit. The pulse width modulation circuit is packaged in the gate driver circuit. The gamma circuit is packaged in the source driver circuit.

A driving system of an LCD includes a control circuit and a driving circuit. The control circuit includes a decoder circuit, a direct current to direct current converter producing an operating voltage, and a timing control circuit producing high-level gate voltages and low-level gate voltages. The driving circuit includes a gate driver circuit, a source driver circuit, a pulse width modulation circuit, and a gamma circuit producing gamma voltages. The direct current to direct current converter provides the operating voltage for the decoder circuit without wires, the pulse width modulation circuit provides the high-level gate voltages and low-level gate voltages for the gate driver circuit without wires, and the gamma circuit provides the gamma voltages for the source driver circuit without wires.

Other novel features and advantages of the above-described circuit will become more apparent from the following detailed description when taken in conjunction with the accompanying drawing.

### BRIEF DESCRIPTION OF THE DRAWING

FIG. 1 is essentially an abbreviated circuit diagram of an LCD panel of an LCD according to a preferred embodiment of the present invention.

FIG. 2 is a block diagram of a driving system of an LCD according to a preferred embodiment of the present invention.

### DETAILED DESCRIPTION OF PREFERRED EMBODIMENTS

Reference will now be made to the drawing to describe the present invention in detail.

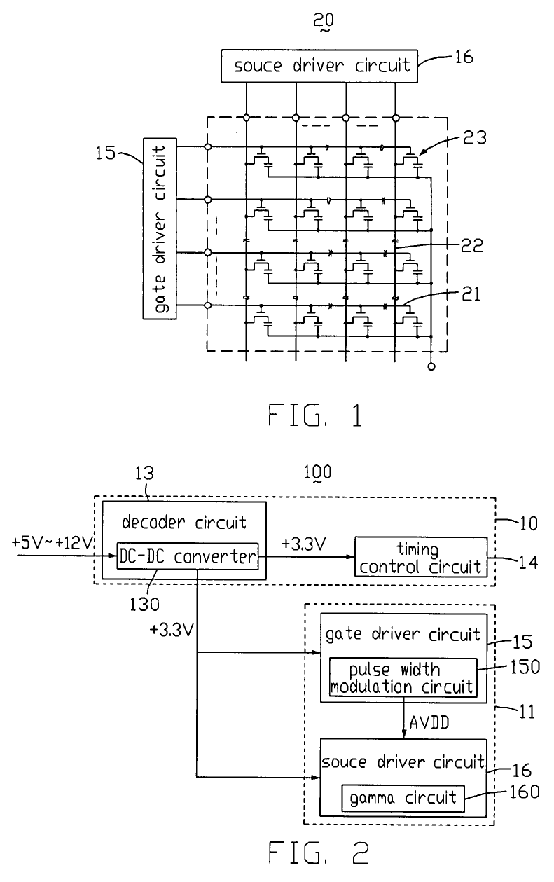

FIG. 1 is essentially an abbreviated circuit diagram of an LCD panel of an LCD according to a preferred embodiment of the present invention. The LCD panel 20 includes a plurality of scan lines 21, a plurality of data lines 22, and a plurality of thin film transistors (TFTs) 23 each connected to a corresponding one of the scan lines 21 and a corresponding one of the data lines 22. The LCD panel 20 also includes a gate driver circuit 15 for driving the plurality of scan lines 21, and a source driver circuit 16 for driving the plurality of data lines 22.

The source driver circuit 16 produces a plurality of gray scale voltages in order to drive the plurality of data lines 22. The gate driver circuit 15 receives a plurality of high-level gate voltages (VGHs) or low-level gate voltages (VGLs). The plurality of VGHs or VGLs turn on or turn off the corresponding TFTs 23 via the corresponding scan lines 21. Normally, a value of the VGH is +15.x V (volts) or +24.x V, wherein x is any natural number; and a value of the VGL is −10.x V or −6.x V, wherein x is any natural number. For example, the VGH may be 15.3 V (when x=3), and the VGL may be 10.2 V (when x=2).

FIG. 2 is a block diagram of a driving system of an LCD according to a preferred embodiment of the present invention. The driving system 100 includes a control circuit 10 and a driving circuit 11. The control circuit 10 is connected to the driving circuit 11 via an FPC (not shown). The control circuit 10 includes a decoder circuit 13 and a timing control circuit 14. The driver circuit 11 includes the gate driver circuit 15 and the source driver circuit 16. The decoder circuit 13 includes a DC-DC converter 130. The gate driver circuit 15 includes a pulse width modulation circuit 150, and the source driver circuit 16 includes a gamma circuit 160.

The DC-DC converter 130, the pulse width modulation circuit 150, and the gamma circuit 160 are packaged in the decoder circuit 13, the gate driver circuit 15, and the source driver circuit 16 respectively. This can be achieved via a multiple chip packaging method.

The DC-DC converter 130 receives a direct current (DC) voltage in a range of +5 V to +12 V from an external power source (not shown), and converts the DC voltage into an operating voltage. The operating voltage is supplied to the decoder circuit 13, the timing control circuit 14, the gate driver circuit 15, and the source driver circuit 16, respectively. A range of the operating voltage is from +2.7 V to +3.6 V; for example, +3.3 V. The timing control circuit 14 generates timing control signals to control the timing sequence of the gate driver circuit 15 and the source driver circuit 16. The pulse width modulation circuit 150 produces VGHs, VGLs, and AVDDs. The VGHs and VGLs are provided to the gate driver circuit 15, and the AVDDs are provided to the source driver circuit 16 as well as the gamma circuit 160. The gamma circuit 160 produces gamma voltages, and provides the gamma voltages to the source driver circuit 16.

The pulse width modulation circuit 150 is packaged in the gate driver circuit 15, and the VGHs and the VGLs are directly provided to the gate driver circuit 15. The gamma circuit 160 is packaged in the source driver circuit 16, thus the gamma voltages are directly provided to the source driver circuit 16. That is, conductive lines normally needed in the associated LCD panel can be omitted. Consequently, the circuit configuration of the driving system 100 is relatively simple.

The FPC only needs a single pin for providing the +3.3 V operation voltage. Thus the cost of the FPC is reduced.

In alternative embodiments, the timing control circuit 14 can be packaged in the decoder circuit 13, or in the source driver circuit 16.

It is to be understood, however, that even though numerous characteristics and advantages of the preferred embodiments have been set out in the foregoing description, together with details of the structures and functions of the embodiments, the disclosure is illustrative only; and that changes may be made in detail, especially in matters of shape, size, and arrangement of parts within the principles of present invention to the full extent indicated by the broad general meaning of the terms in which the appended claims are expressed.

What is claimed is:

1. A driving system of a liquid crystal display, the driving system comprising:
a control circuit comprising a decoder circuit, a direct current to direct current converter, and a timing control circuit; and
a driving circuit comprising a gate driver circuit, a source driver circuit, a pulse width modulation circuit, and a gamma circuit;
wherein the direct current to direct current converter is packaged in the decoder circuit, the pulse width modulation circuit is packaged in the gate driver circuit, and the gamma circuit is packaged in the source driver circuit.

2. The driving system as claimed in claim 1, wherein the direct current to direct current converter is packaged in the decoder circuit via a multiple chips package method.

3. The driving system as claimed in claim 1, wherein the pulse width modulation circuit is packaged in the gate driver circuit via a multiple chips package method.

4. The driving system as claimed in claim 1, wherein the gamma circuit is packaged in the source driver circuit via a multiple chips package method.

5. The driving system as claimed in claim 1, wherein the direct current to direct current converter receives a direct current voltage from an external power source and converts it into an operating voltage supplied to the decoder circuit, the timing control circuit, the gate driver circuit, and the source driver circuit, respectively.

6. The driving system as claimed in claim 5, wherein a range of the direct current voltage is from +5 V to +12 V.

7. The driving system as claimed in claim 5, wherein a range of the operating voltage is from +2.7 V to +3.6 V.

8. The driving system as claimed in claim 7, wherein the operating voltage is +3.3 V.

9. The driving system as claimed in claim 1, wherein the pulse width modulation circuit produces high-level gate voltages and low-level gate voltages to provide to the gate driver circuit, and produces main operation voltages to provide to the source driver circuit and the gamma circuit.

10. The driving system as claimed in claim 1, wherein the gamma circuit produces gamma voltages to provide to the source driver circuit.

11. The driving system as claimed in claim 1, wherein the timing control circuit is packaged in the decoder circuit.

12. The driving system as claimed in claim 1, wherein the timing control circuit is packaged in the source driver circuit.

13. A driving system of a liquid crystal display, the driving system comprising:
a control circuit comprising a decoder circuit, a direct current to direct current converter producing an operating voltage, and a timing control circuit producing high-level gate voltages and low-level gate voltages; and
a driving circuit comprising a gate driver circuit, a source driver circuit, a pulse width modulation circuit, and a gamma circuit producing gamma voltages;
wherein the direct current to direct current converter provides the operating voltage for the decoder circuit without wires, the pulse width modulation circuit provides the high-level gate voltages and low-level gate voltages for the gate driver circuit without wires, and the gamma circuit provides the gamma voltages for the source driver circuit without wires.

14. The driving system as claimed in claim 13, wherein the direct current to direct current converter receives a direct current voltage from an external power source and converts it into the operating voltage.

15. The driving system as claimed in claim 14, wherein a range of the direct current voltage is from +5 V to +12 V.

16. The driving system as claimed in claim 14, wherein a range of the operating voltage is from +2.7 V to +3.6 V.

17. The driving system as claimed in claim 16, wherein the operating voltage is +3.3 V.

18. The driving system as claimed in claim 13, wherein the pulse width modulation circuit produces main operation voltages to provide to the source driver circuit and the gamma circuit.
